(19) United States
(12) Patent Application Publication
(10) Pub. No.: US 2008/0081153 A1
(43) Pub. Date: Apr. 3, 2008

(54) Sports mat

(76) Inventor: Tzong In Yeh, Fremont, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 11/653,208

(22) Filed: Jan. 16, 2007

(30) Foreign Application Priority Data
Oct. 2, 2006 (TW) 095136620

(51) Int. Cl. B32B 3/00

(52) U.S. Cl. 428/156

(57) ABSTRACT

A sports mat includes a first foam layer, a second foam layer and a patterned laminate. The first foam layer is made of skid-proof foam material for contacting the floor. The second foam layer is disposed on the first foam layer and made of soft foam material. The patterned laminate includes a first plastic film, a second plastic film and a pattern. The first plastic film is disposed on the second foam layer. The pattern is provided between the first and second plastic films and visible through the second plastic film.

### BACKGROUND OF INVENTION

1. Field of Invention

The present invention relates to a sports mat and in particular to a yoga mat.

2. Related Prior Art

Recently, exercise has gained popularity among people. Many people go to gyms for exercise. Accordingly, it is necessary to choose a safe and comfortable sports mat. The sports mat protects a user's body from getting hurt while performing an exercise, such as Yoga, Pilates, push up or sit-up.

U.S. patent application No. 2004/0250346 discloses a skid-proof multi-layer yoga mat which includes an upper fabric layer, a lower pliable foam layer, and an intermediate adhesive such that during use the mat provides the athlete with safety and comfort and during transport or storage the rolled-up mat provides convenience.

However, the conventional sports mat is dull. This can't satisfy customers' desire for beauty. Nevertheless, the manufacturing process of the mats includes a plurality of steps, such as twisting, plunging and the like. The different colors of materials may be mixed up during the process so that a fresh colorful mat is still needed.

Hence, Taiwan Patent M251621, for example, discloses a yoga mat to enhance visual effects. The yoga mat comprises two transparent layers and a partly colored meshed laminate disposed between the two transparent layers. The colors of the laminate are visible through the transparent layers. The visual effects are improved but to a limited extent.

What is desired, therefore, is a safe, comfortable and beautiful sports mat, which helps the athlete to enjoy exercising with a nice feeling.

### SUMMARY OF INVENTION

The primary object of this invention is therefore to provide a sports mat with functionality and visual effects.

According to the present invention, a sports mat comprises a first foam layer, a second foam layer and a patterned laminate. The first foam layer is made of skid-proof foam material for contacting the floor. The second foam layer is disposed on the first foam layer and made of soft foam material. The patterned laminate comprises a first plastic film, a second plastic film and a pattern. The first plastic film is disposed on the second foam layer. The pattern is provided between the first and second plastic films and is visible through the second plastic film.

Preferably, the first foam layer defines a plurality of parallel grooves on the bottom thereof, parallel with an axis about which the sports mat can be rolled so that no crimp will occur on the sports mat when the sports mat is rolled.

Preferably, the sports mat further comprises a net disposed between the first and second foam layers so as to enhance the resilience of the sports mat.

Further benefits and advantages of the present invention will become clear as the description proceeds.

### BRIEF DESCRIPTION OF DRAWINGS

The invention will now be elucidated by reference to the following description and accompanying drawings where:

FIG. 1 is an exploded view of a sports mat according to the preferred embodiment of the present invention;

FIG. 2 is a cross-sectional view of the sports mat of FIG. 1;

FIG. 3 is a perspective view of the sports mat, showing the sports mat is rolled up; and

FIG. 4 shows another example of a first foam layer.

### DETAILED DESCRIPTION OF PREFERRED EMBODIMENT

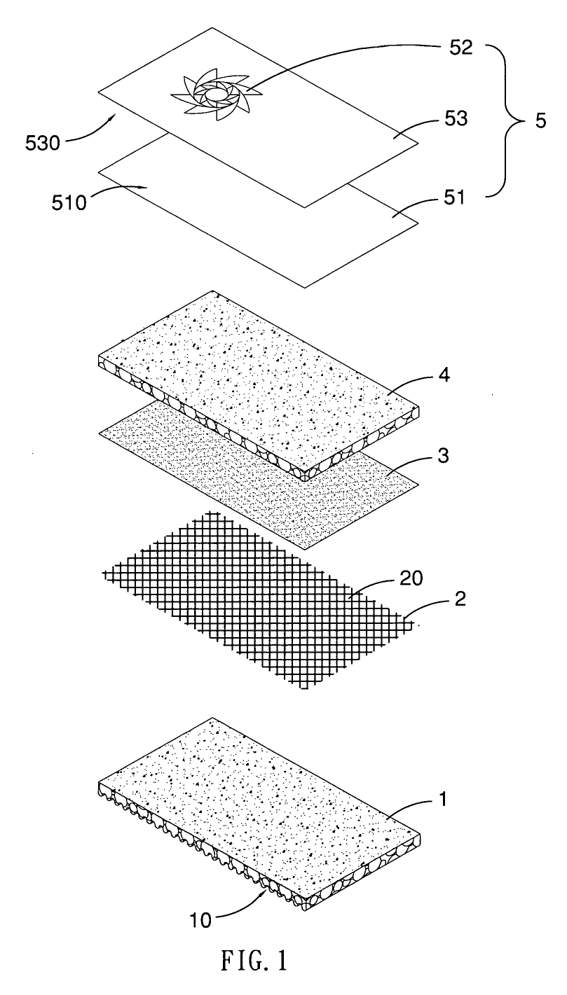

With reference to FIGS. 1 to 3, description will be given of a sports mat according to the preferred embodiment of this invention.

Referring to FIG. 1, the sports mat comprises a first foam layer 1, a net 2, an adhesive layer 3, a second foam layer 4 and a patterned laminate 5.

The first foam layer 1 is provided for contacting the floor (not shown) and is made of skid-proof foam material, such as ethylene copolymer elastomer, due to an increased coefficient of friction with the floor for resisting slippage at its interface. The foam density of the ethylene copolymer elastomer is preferably 2 to 8 pcf and more preferably 4 pcf. The thickness of the first foam layer 1 is preferably 1 to 4 mm and more preferably 2 mm. In addition, the first foam layer 1 is embossed with parallel ridges 11 separated from one another by grooves 10.

The net 2 comprises a plurality of meshes 20 and is disposed between the first and the second foam layers 1 and 4 so as to enhance the strength of the foam layers 1 and 4 and prevent the sports mat from being distorted while in use. Thus, when a rolled-up sports mat is unrolled and spread up, the net 2 provides enough resilience for evening the same immediately. For this purpose, the net 2 is made of elastic material, such as a plastic net sheet, cloth, fabric or the like.

For tenderness of the sports mat, the second foam layer 4 is made of soft foam material, such as ethylene vinyl acetate copolymer (EVA). The foam density of EVA is preferably 1.2 to 6 pcf and more preferably 3 pcf. The thickness of the second foam layer 4 is preferably 1 to 4 mm and more preferably 2 mm.

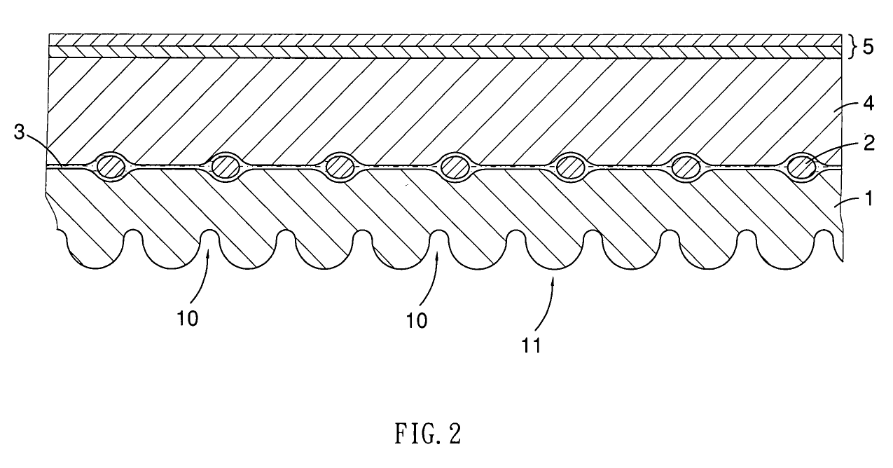

In principle, the net 2, the first foam layer 1 and the second foam layer 4 are made of similar materials so that they can be easily combined together via a heat lamination process without need of the adhesive layer 3. However, in the preferred embodiment, the adhesive layer 3 is provided and can be solid or liquid copolymer adhesives, general adhesives or the like. First, the material of the adhesive layer 3 is coated on either the first foam layer 1 or the second foam layer 4. Then, the material of the adhesive layer 3, as well as part of the materials of the foam layers 1 and 4, is fused by heat laminating and penetrates into the meshes 20 of the net 2 as shown in FIG. 2 so as to become a high-strength combination after hardening.

The patterned laminate 5 comprises a first plastic film 51, a pattern 52 and a second plastic film 53. The first plastic film 51 is made of polyethylene or the like, so that it can be heat-laminated on the second foam layer 4. Preferably, the first plastic film 51 has a thickness in the range of 0.01 to 0.07 mm, and especially 0.015 mm. The second plastic film 53 is provided on the first plastic film 51 and is also made of polyethylene. The thickness of the second plastic film 52 is preferably 0.015˜0.1 mm and more preferably 0.03 mm. The second plastic film 53 is especially transparent or half-transparent so that the pattern 52 printed on either an outer surface 510 of the first plastic film 51 or an inner surface 530 of the second film 53 can be seen through the second plastic film 53. In this state, the pattern 52 can be protected from color fading by the first and second films 51 and 53. In addition, the pattern 52 made of chemical compositions is isolated from a user's skin, so that it is safe to a user. In other words, a variety of colorful patterns with designs or marks can be provided on the sports mat which would otherwise be dull.

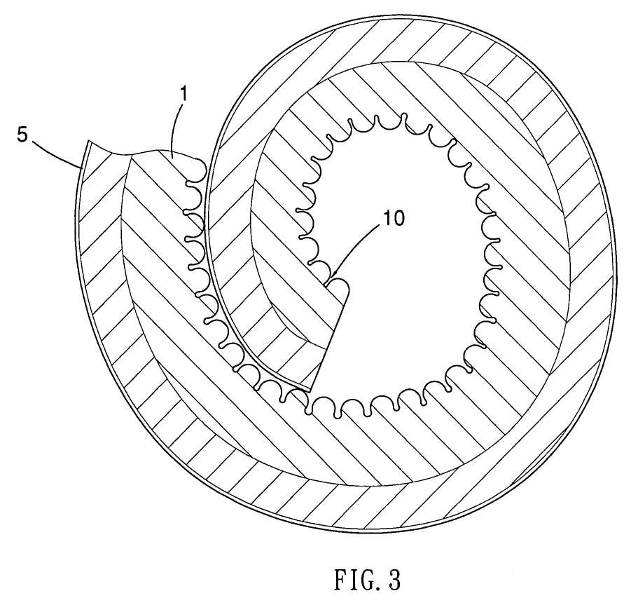

For skid-proof purposes, the top of the sports mat, namely the patterned laminate 5, can be embossed with irregular patterns with concaves, the embossed patterns can be lines, dots and the like, so as to prevent the athlete or user from slipping and tumbling. On the bottom of the sports mat, namely the first foaming layer 1, is embossed with grooves 10 and the ridges 11 parallel with an axis about which the sports mat can be rolled. Thus, as depicted in FIG. 3, when the sports mat is rolled up, the first foam layer 1 provides rooms, namely the grooves 10, for wresting so that the sports mat won't become shrunk. In practice, the depth of the grooves 10 is preferably about 0.25 to 2 mm, and the interval between two adjacent grooves 10 is preferably 3 mm. The total thickness of the first and the second foam layers 1 and 4 is preferably in the range of 2 to 8 mm. The thickness of the first foam layer 1 is not necessary to be the same with that of the second foam layer 4. In this way, the sports mat can have excellent rolling effects as well as the characteristic itself.

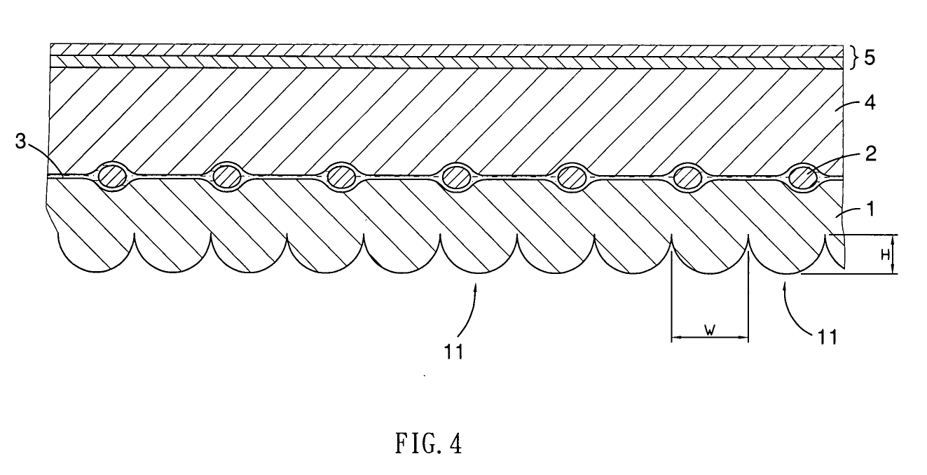

FIG. 4 shows another example of the first foam layer 1 which is shaped as a contour different from that of the prior example. In this example, the first foam layer 1 is embossed with ridges 11 closely connected to one another. In this example, the height H of each ridge 11 is preferably 0.5 to 3 mm. The width W of each ridge 11 is preferably. In this manner, the first foam layer 1 has similar effects and benefit as described above.

As stated above, the sports mat of the present invention satisfies the desire of beauty as well as the needs of comfort, safety and high elasticity. Additionally, for a further application, the present invention not only can be applied to sports mats, but also can be applied to other mats, such as pet mats.

Numerous characteristics and advantages of the invention have been set forth in the foregoing description. The disclosure, however, is illustrative only, and changes may be made in detail within the principle of the invention, to the full extent indicated by the broad general meaning of the terms in which the appended claims are expressed.

1. A sports mat comprising:
a first foam layer made of skid-proof foam material for contacting the floor;
a second foam layer disposed on the first foam layer and made of soft foam material; and
a patterned laminate comprising a first plastic film disposed on the second foam layer, a second plastic film and a pattern provided between the first and second films and visible through the second film.

2. The sports mat of claim 1 wherein the pattern laminate is embossed.

3. The sports mat of claim 1 comprising a net disposed between the first and the second foam layer so as to provide resilience for the sports mat.

4. The sports mat of claim 3 wherein the net is made of plastic material.

5. The sports mat of claim 3 comprising an adhesive layer provided between the first and the second foam layers, wherein the adhesive layer penetrates meshes of the net.

6. The sports mat of claim 1, wherein the first foam layer defines a plurality of parallel grooves on the bottom thereof, which parallel with the axis of the rolled-up sports mat.

7. The sports mat of claim 3, wherein the first foam layer defines a plurality of parallel grooves on the bottom thereof, which parallel with the axis of the rolled-up sports mat.

8. The sports mat of claim 5, wherein the first foam layer defines a plurality of parallel grooves on the bottom thereof, which parallel with the axis of the rolled-up sports mat.

9. The sports mat of claim 1, wherein the skid-proof foam material is ethylene copolymer elastomer with a density in the range of 2 to 8 pcf, and a thickness in the range of 1 to 4 mm.

10. The sports mat of claim 9, wherein the soft foam material is ethylene vinyl acetate copolymer with a density in the range of 1.2 to 6 pcf and a thickness in the range of 1 to 4 mm.

11. The sports mat of claim 3, wherein the net is made of fabric.
